(19) United States
(12) Patent Application Publication
(10) Pub. No.: US 2014/0109672 A1
(43) Pub. Date: Apr. 24, 2014

(54) Laboratory Apparatus Comprising a Sensor for Detecting Vibrations

(71) Applicant: Erhard Eble, Bad Krozingen (DE)

(72) Inventor: Erhard Eble, Bad Krozingen (DE)

(73) Assignee: IKA-Werke GmbH & Co. KG, Staufen (DE)

(21) Appl. No.: 14/119,326

(22) PCT Filed: Mar. 28, 2012
(86) PCT No.: PCT/EP2012/001366

§ 371 Date: Nov. 21, 2013

(30) Foreign Application Priority Data
May 27, 2011 (DE) 10 2011 102 607.3

(51) Int. Cl. G01M 1/22

(52) U.S. Cl. CPC G01M 1/22
USPC 73/462

(57) ABSTRACT

The invention relates to a laboratory apparatus (1) which comprises an electric drive (4), and which is equipped with a device (10) with at least one sensor (13) for detecting vibrations, oscillations or imbalances. Said device (10) fits together with a mating coupling located on the laboratory apparatus (1) by means of a coupling (11) located on said device. Once in the coupled position, the device is connected to the laboratory apparatus (1) or to the controller or to the drive of said apparatus, either wirelessly or via electrical contacts. If any vibrations, oscillations or imbalances occur, they are detected by the sensor (13), which is connected or wired to the closed- or open-loop control of the drive motor via the connection between the coupling (11) and the mating coupling (12), and which can switch off the drive motor (4) or change the speed thereof in the event of undesired or dangerous oscillations, vibrations or imbalances.

### CROSS-REFERENCE TO RELATED APPLICATIONS

This application claims priority from PCT/EP2012/001366, filed Mar. 28, 2012, which claims priority from DE 10 2011 102 607.3, filed May 27, 2011, which are hereby incorporated by reference herein in their entireties.

### FIELD OF THE INVENTION

The invention relates to a laboratory apparatus comprising a drive and at least one device having at least one sensor for detecting vibrations or oscillations or imbalance.

### STATE OF THE ART

Such apparatuses for detecting vibrations or imbalance or oscillations comprising a commensurate sensor are known, for example, from earthquake measurement.

In engineering and particularly in laboratory apparatuses, the problem often occurs of having to detect vibrations, oscillations or imbalances, or having to accept damage to or destruction of the corresponding laboratory apparatus or of the experimental setup. In extreme cases, even the endangering of the user of the corresponding laboratory apparatus cannot be ruled out.

While laboratory apparatuses are known in which vibrations or imbalances can be detected by such built-in sensors, this is not the case for many laboratory apparatuses and, what is more, such a laboratory apparatus must also have a commensurate construction.

### SUMMARY OF THE INVENTION

It is therefore the object to provide a device comprising at least one sensor for detecting vibrations or oscillations or imbalances which can be provided or mounted on practically any laboratory apparatus.

To achieve this object, the laboratory apparatus with the device defined at the outset is characterized in that this device comprises a coupling that fits together with a mating coupling arranged on the laboratory apparatus, that the coupling is connected to the mating coupling in the operating position, and that the apparatus is connected in this operating position to the laboratory apparatus and/or its open-loop control or feedback control by wireless or wired means via electrical contacts.

In this way, the device with sensor for detecting imbalance can be mounted—particularly even subsequently—on practically any laboratory apparatus, which generally has an electrical interface, in order to influence the open-loop motor control of the drive of the laboratory apparatus depending on detected vibrations, oscillations or imbalances that occur by reducing or increasing the speed of the drive motor or switching the motor off. According to the invention, the device is thus connected to the control of the drive motor.

One particularly expedient embodiment can consist in the mating coupling of the laboratory apparatus being its electrical interface and in the sensor being preferably connected to an acoustic and/or optical display or signal device. If the coupling of the device is adapted to the electrical interface of the laboratory apparatus as a mating coupling, the device according to the invention can also be mounted subsequently on practically any laboratory apparatus with such an interface particularly in order to influence the control of the drive depending on the vibrations or oscillations or imbalances detected. It is especially favorable in this respect if a standard interface is used as a mating coupling on the laboratory apparatus which is present, namely, on practically every laboratory apparatus. The user needs only to plug the device having the sensor onto this standard interface in order to obtain the desired monitoring and influencing of the control and, depending on the configuration, an acoustic and/or optical display or signal device can then draw attention to possibly dangerous oscillations, vibrations or imbalances.

The sensor can thus be connected to the control of the drive motor via the mating coupling embodied as an interface and change the motor speed upon overshooting of a threshold, particularly reduce or increase it or shut the drive motor off. Through such a configuration, automatic prevention or elimination of damage caused by imbalance or by vibrations or oscillations can thus be achieved even in laboratory apparatuses that are not originally provided with such monitoring or such a sensor.

If the mating coupling on the laboratory apparatus is a standard interface and the coupling of the device fits together with it, the subsequent mounting of such a device on practically any laboratory apparatus in which imbalances or oscillations can occur is easily possible. The user need only plug the device onto this standard interface in order to achieve the desired monitoring.

A modified embodiment can make a provision that a mechanical mating coupling of the laboratory apparatus fits together with a mechanical coupling of the device and the sensor is wirelessly connected to the motor control—in the operating position—and has a transmitter and preferably its own power source, the laboratory apparatus having a receiver matching with the sensor and its transmitter. This arrangement can be expedient if a matching interface is not present on the laboratory apparatus or is not usable.

It is favorable if the receiver in the laboratory apparatus is designed to work together with a remote control and the transmitter of the device is adapted to this receiver. It is already common in a large number of laboratory apparatuses to actuate them exclusively or additionally by means of remote control, so a corresponding receiver is present. This can be exploited if the device with the sensor has a corresponding transmitter.

The sensor can be an acceleration sensor. An acceleration sensor can easily detect shaking or rocking motions of the laboratory apparatus equipped with it and therefore response to vibrations, oscillations and imbalances.

Here, the sensor can be piezo-based or inductive with plunger or embodied by deflectable mass or at least one strain gauge. Sensors configured in this way have proven their worth in the detection of vibrations, oscillations or imbalances, so that a commensurate use in connection with the laboratory apparatus according to the invention constitutes a low-cost solution.

The device to be coupled with the laboratory apparatus can have a signal device or lamp that indicates readiness for operation upon coupling of the device with the laboratory apparatus. As a result, the user is given commensurate control when coupling the device with the laboratory apparatus.

Another modified embodiment can make a provision that the device with the sensor has a connection to the power supply of the laboratory apparatus and the current for the drive motor of the laboratory apparatus is fed via the device in the operating position and that the device particularly has a device for interrupting the power supply when a threshold is exceeded for vibrations or oscillations or imbalances. In such an embodiment and arrangement, older laboratory apparatuses with simpler controls for their drives can also be provided subsequently with a sensor and switched off in the event of excessive vibrations, oscillations or imbalances.

Especially the combination of individual or several of the features and measures described above makes it possible to provide an already existing laboratory apparatus subsequently or a new laboratory apparatus from the outset with a sensor in order to then enable reaction to vibrations, oscillations or imbalances in one or another described manner. New laboratory apparatuses can also be equipped in this way and then require practically no additional measures during the manufacture thereof, since the device with sensor can be coupled to them in the described manner.

### BRIEF DESCRIPTION OF THE DRAWINGS

In the following, an exemplary embodiment is described in further detail with reference to the drawing. In partially schematic illustration:

FIG. 1 shows a front view,

FIG. 2 shows a side view held partially in longitudinal section,

FIG. 3 shows a rear view,

FIG. 4 shows a top view of the laboratory apparatus according to the invention, with the device with sensor being shown in FIG. 4 before coupling with the interface of the laboratory apparatus, and

FIG. 5 shows a top view corresponding to FIG. 4 of the laboratory apparatus with coupled-on device with sensor.

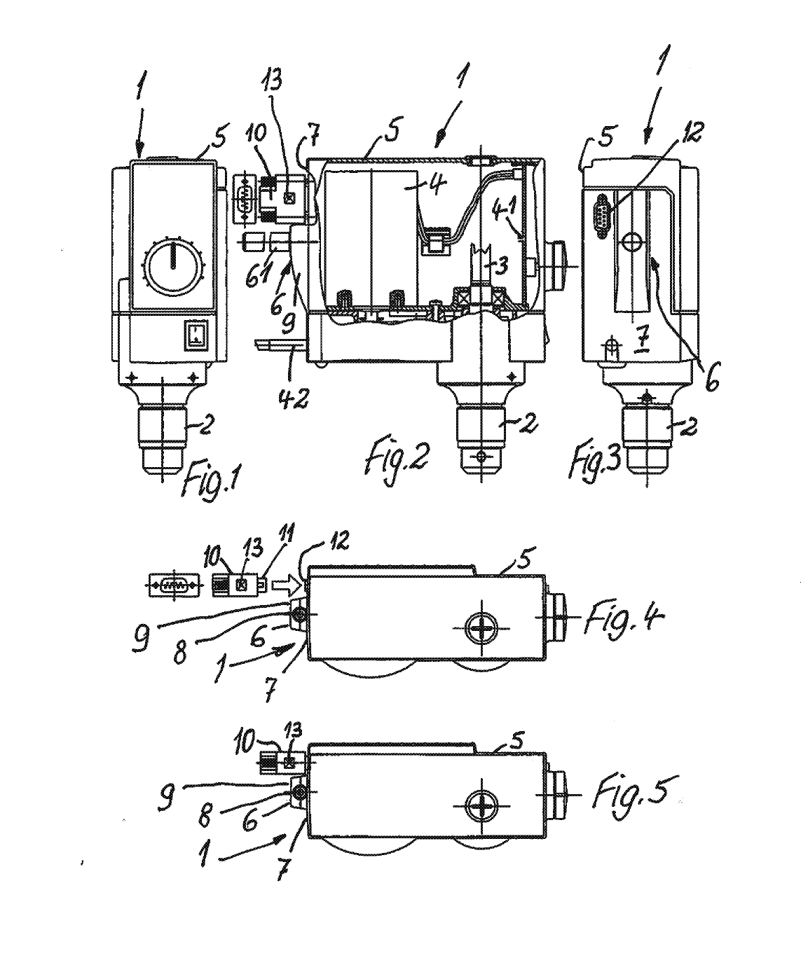

### DETAILED DESCRIPTION OF THE PREFERRED EMBODIMENT

In the exemplary embodiment, the laboratory apparatus designated throughout with 1 is a stirring device that is provided for the purpose of stirring a mass or liquid into which a stirring tool can be introduced. This stirring tool can be coupled with a chuck 2 which, in turn, is connected via a shaft 3 to an electric drive motor 4 either directly or via a gear mechanism so that, after insertion of a stirring tool into the chuck 2, stirring can be performed by switching this drive motor 4 on. The open-loop control or feedback control of the drive motor 4 is provided on a printed circuit board 41.

The drive motor 4 is accommodated in a housing 5 which encloses it and on whose outside surface an attachment point is provided for fixing this laboratory apparatus 1 in the operating position. In the exemplary embodiment, one can see, as an attachment point 6 on the rear wall 7 of the housing 5, a console 9 provided with an attachment screw 8 which enables the plugging-on of the laboratory apparatus with this attachment point 6 onto a horizontal arm 61 of a stand. The power supply for the drive motor 4 occurs via a cable 42.

Instead of a stirring device, the laboratory apparatus 1 could also be a mixing device or a shaking device or another laboratory device.

For this reason, in all of these cases, including in the exemplary embodiment, a device 10 having a sensor 13 is provided for the detection of vibrations or oscillations or imbalances which has a coupling 11 according to FIG. 4 that fits together with a mating coupling 12 arranged on the laboratory apparatus 1.

Whereas, according to FIG. 4, the device 10 with its coupling 11 is not yet coupled with and connected to the laboratory apparatus 1, this is already the case in FIGS. 2 and 4. In the operating position, the coupling 11 is therefore connected to the mating coupling 12 of the laboratory apparatus 1 and, furthermore, the device 10 is connected in this operating position to the laboratory apparatus 1 and its control and/or its drive 4 either wirelessly or via electrical contacts.

It can be seen in the figures that the mating coupling 12 is the electrical interface of the laboratory apparatus 1 in the exemplary embodiment, so that the device 10 according to FIGS. 4 and 5 can also easily be connected and coupled subsequently to such a laboratory apparatus 1 in order to monitor it with regard to vibrations, oscillations or imbalances. An acoustic and/or optical display or signal device could also be controlled via the sensor 13.

The sensor 13 connected to the control of the drive motor 4 mating coupling 12 embodied as an interface can change the motor speed upon overshooting of a threshold, particularly reduce or increase it or switch the drive motor 4 off. In any case, with this device that can easily be connected to the laboratory apparatus 1, damage as a result of excessive vibrations or oscillations or imbalances can be prevented from occurring.

In the exemplary embodiment according to FIG. 3, the mating coupling 12 on the laboratory apparatus 1 is a standard interface with which the coupling 11 of the device 10 fits due to a commensurate design. The sensor 13 can be an acceleration sensor so that it responds especially well to imbalances or even to vibrations and oscillations. It can be piezo-based or inductive with plunger or embodied by means of deflectable mass or by means of at least one strain gauge.

The laboratory apparatus 1 with an electric drive 4 is equipped with a device 10 for the detection of vibrations, oscillations or imbalances having at least one sensor 13, the device 10 fitting together with a mating coupling located on the laboratory apparatus 1 via a coupling 11 located on the device 10 and being connected in the coupled position to the laboratory apparatus 1 or its control or its drive either wirelessly or via electrical contacts. If vibrations, oscillations or imbalances occur, they are detected by the sensor 13 which, through the connection of the coupling 11 to the mating coupling 12, is connected to or interconnected with the open-loop control or the feedback control of the drive motor 4 and can switch the drive motor 4 off or change its speed in the event of undesired or dangerous oscillations, vibrations or imbalances.

1. Laboratory apparatus (1) comprising a drive (4) and at least one device (10) having a sensor (13) for detecting vibrations or oscillations or imbalance, characterized in that the device (10) has a coupling (11) that fits together with a mating coupling (12) arranged on the laboratory apparatus (1), that the coupling (11) is connected in the operating position to the mating coupling (12), and that the device (10) is connected in this operating position to the laboratory apparatus (1) either wirelessly or via electrical contacts.

2. Laboratory apparatus as set forth in claim 1, characterized in that the mating coupling (12) of the laboratory apparatus (1) is its electrical interface and that the sensor (13) is preferably connected to an acoustic and/or optical display or signal device.

3. Laboratory apparatus as set forth in claim 1, characterized in that the sensor (13) is connected via the mating coupling (12) embodied as an interface to a control of the drive motor (4) and changes the motor speed upon overshooting of a threshold or switches the drive motor (4) off.

4. Laboratory apparatus as set forth in claim 1, characterized in that the mating coupling (12) on the laboratory apparatus (1) is a standard interface and the coupling (11) of the device (10) fits with it.

5. Laboratory apparatus as set forth in claim 1, characterized in that a mechanical mating coupling of the laboratory apparatus (1) fits together with a mechanical coupling of the device (10) and the sensor (13) is wirelessly connected to the motor control and has a transmitter, and that the laboratory apparatus (1) has a receiver which matches with the sensor (13) and the transmitter.

6. Laboratory apparatus as set forth in claim 5, characterized in that a receiver is designed to work together with a remote control and the transmitter of the device (10) is adapted to the receiver.

7. Laboratory apparatus as set forth in claim 1, characterized in that the sensor (13) is an acceleration sensor.

8. Laboratory apparatus as set forth in claim 1, characterized in that the sensor is piezo-based or inductive with plunger or embodied by means of deflectable mass or by means of at least one strain gauge.

9. Laboratory apparatus as set forth in claim 1, characterized in that the device (10) has a signal device or lamp that displays readiness to operate upon coupling of the device with the laboratory apparatus.

10. Laboratory apparatus as set forth in claim 1, characterized in that the device (10) with the sensor (13) has a connection to a power supply of the laboratory apparatus (1) and the current for the drive motor (4) of the laboratory apparatus (1) is fed in the operating position via the device (10), and that the device (10) is adapted to interrupt the power supply upon overshooting of a threshold for vibrations or oscillations.
